(19) United States
(12) Patent Application Publication
(10) Pub. No.: US 2026/0043390 A1
(43) Pub. Date: Feb. 12, 2026

(54) Fluid Pressure Actuator and Attachment

(71) Applicant: KOGANEI CORPORATION, Tokyo (JP)

(72) Inventors: Hiraku SAKAI, Tokyo (JP); Takeshi YAMAUCHI, Tokyo (JP)

(73) Assignee: KOGANEI CORPORATION, Tokyo (JP)

(21) Appl. No.: 19/363,372

(22) Filed: Oct. 20, 2025

Related U.S. Application Data
(63) Continuation of application No. PCT/JP2024/009409, filed on Mar. 11, 2024.

(30) Foreign Application Priority Data
Apr. 20, 2023 (JP) 2023-069491

(51) Int. Cl. F03G 7/06; B25J 9/14

(52) U.S. Cl. CPC F03G 7/061; B25J 9/144; F03G 7/0645

(57) ABSTRACT

There is provided a fluid pressure actuator includes an elastic tube including a tube body and a reinforcement member and being radially expanded and axially contracted by a fluid pressure supplied to the tube body. The fluid pressure actuator includes a first holder mounted on a first end of the elastic tube, and a second holder mounted on a second end of the elastic tube. The fluid pressure actuator includes a plate member being provided between the first holder and the second holder, being arranged outside the elastic tube, and having a corrugated part. The fluid pressure actuator includes a coupling member holding the plate member and the elastic tube.

### CROSS-REFERENCE TO RELATED APPLICATIONS

This is a continuing application, under 35 U.S.C. § 120, of copending international application No. PCT/JP2024/009409, filed Mar. 11, 2024, which designated the United States and was not published in English; this application also claims the priority, under 35 U.S.C. § 119, of Japan patent application No. 2023-069491, filed Apr. 20, 2023; the prior applications are herewith incorporated by reference in their entirety.

### STATEMENT REGARDING FEDERALLY SPONSORED RESEARCH OR DEVELOPMENT

Not Applicable

### FIELD OF THE INVENTION

The present disclosure relates to a fluid pressure actuator and an attachment.

### BACKGROUND OF THE INVENTION

In related arts, elastic tubes each being axially contracted by pressure of a fluid such as compressed air have been known. In addition, the following fluid pressure actuators each bending the elastic tube have been known.

A Patent Document 1 discloses a fluid pressure actuator including a flat plate-shaped restraint member between a tube and a sleeve that covers the tube. When the tube is axially contracted by supply of the compressed air to this fluid pressure actuator, the fluid pressure actuator bends in a state in which the restraint member is arranged outside.

In addition, A Non-Patent Document 1 discloses a fluid pressure actuator including a soft sleeve around a tube. On a side surface of the sleeve that covers the tube, a plurality of slits constituting a bellows part are formed. When the tube is axially contracted by supply of the compressed air to this fluid pressure actuator, the fluid pressure actuator bends in a state in which the bellows part of the sleeve is arranged inside.

Patent Document 1: Japanese Patent Application Laid-Open Publication No. 2021-088999. The fluid pressure actuator disclosed in the Patent Document 1 has a structure in which the restraint member is inserted between the tube and the sleeve. Thus, the insertion of the restraint member between the tube and the sleeve is a factor that complicates a manufacturing process of the fluid pressure actuator, and a factor that increases a cost of the fluid pressure actuator.

Non-Patent Document 1: F. Zhao, S. Dohta and T. Akagi, Development and Analysis of Bending Actuator Using McKibben Artificial Muscle, Journal of System Design and Dynamics, Vol. 6 No. 2 (2012), p.158 to 169. A fluid pressure actuator disclosed in the Non-Patent Document 1 includes a bellows-like soft sleeve, and thus, a bending shape of the fluid pressure actuator is unstable, and besides, it is difficult to maintain the posture of the fluid pressure actuator.

### SUMMARY OF THE INVENTION

The present disclosure describes providing a low-cost fluid pressure actuator and attachment capable of maintaining the posture.

According to the present disclosure, a fluid pressure actuator includes an elastic tube including a tube body and a reinforcement member and being radially expanded and axially contracted by a fluid pressure supplied to the tube body. The fluid pressure actuator includes a first holder mounted on a first end of the elastic tube, and a second holder mounted on a second end of the elastic tube. The fluid pressure actuator includes a plate member being provided between the first holder and the second holder, being arranged outside the elastic tube, and having a corrugated part. The fluid pressure actuator includes a coupling member holding the plate member and the elastic tube.

According to the present disclosure, an attachment is used while being mounted on an elastic tube being radially expanded and axially contracted by a fluid pressure supplied to a tube body. The attachment includes a first holder for mounting on the elastic tube and a second holder for mounting on the elastic tube. The attachment includes a plate member being provided between the first holder and the second holder and including a corrugated part. The attachment includes a coupling member for holding the plate member and the elastic tube.

According to the present disclosure, since the plate member is provided between the first holder and the second holder, the posture can be maintained while the cost is suppressed.

### BRIEF DESCRIPTION OF THE DRAWINGS

FIG. 1 is a perspective view illustrating a fluid pressure actuator according to an embodiment;

FIG. 2 is a is a cross-sectional view illustrating the fluid pressure actuator;

FIG. 3 is a is a perspective view illustrating a part of an elastic tube;

FIG. 4A is a diagram illustrating the fluid pressure actuator in an initial state;

FIG. 4B is a diagram illustrating the fluid pressure actuator in a bending state;

FIG. 5 is a perspective view illustrating a gripping device using the fluid pressure actuator;

FIG. 6A is a diagram illustrating a plate member;

FIG. 6B is a diagram illustrating a modification example of the plate member;

FIG. 6C is a diagram illustrating a modification example of the plate member;

FIG. 6D is a diagram illustrating a modification example of the plate member;

FIG. 6E is a diagram illustrating a modification example of the plate member; and

FIG. 7 is a diagram illustrating a modification example of the fluid pressure actuator and an attachment.

### DETAILED DESCRIPTION OF THE EMBODIMENTS

Hereinafter, embodiments of the present disclosure will be described with reference to the accompanying drawings. Note that the same or substantially same components and elements are denoted with the same reference symbols in the following description, and the repetitive description thereof will be omitted.

### Configuration of Fluid Pressure Actuator and Attachment

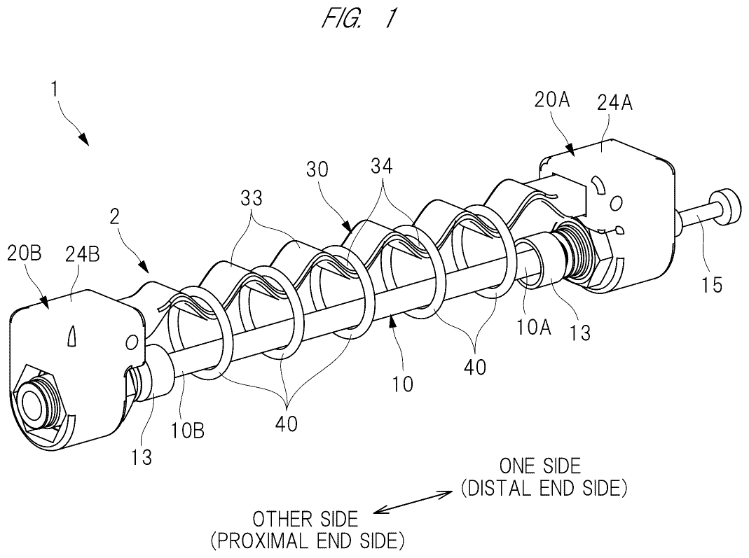

As illustrated in FIG. 1, a fluid pressure actuator 1 includes an elastic tube 10 and an attachment 2 mounted on the elastic tube 10. The attachment 2 includes a joint holder (first holder) 20A for mounting on the elastic tube 10 and a joint holder (second holder) 20B for mounting on the elastic tube 10. In addition, the attachment 2 includes a plate member 30 provided between the joint holder 20A and the joint holder 20B and an O-ring (coupling member, annular member) 40 for holding the plate member 30 and the elastic tube 10.

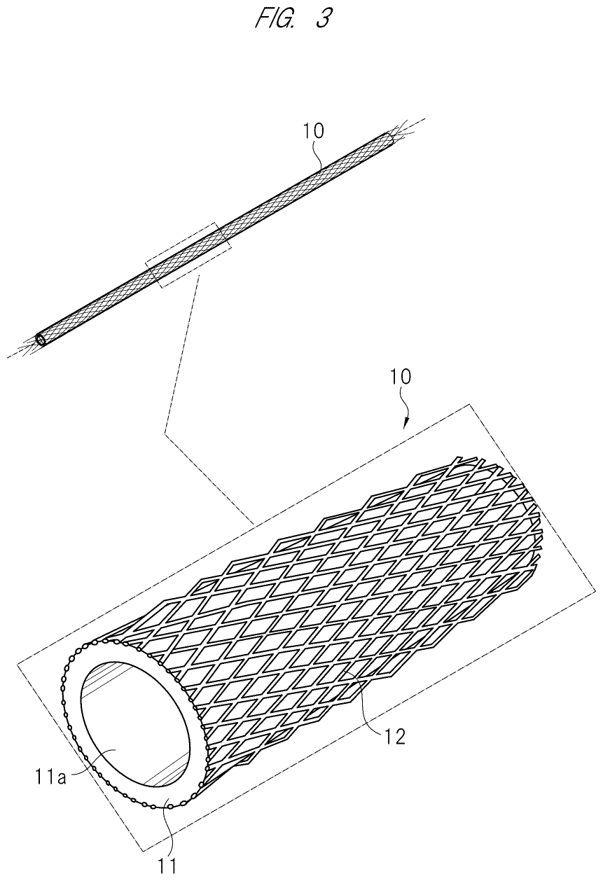

As illustrated in FIG. 3, the elastic tube 10 is made of a tube body 11 and a braided sleeve 12 as an example of a reinforcement member. The tube body 11 is made of an elastically deformable material such as synthetic resin or synthetic rubber. The braided sleeve 12 has a mesh-like structure formed by cylindrically braiding threads made of polyester resin, polyamide resin, or the like. The outside of the tube body 11 is coated with the braided sleeve 12. The elastic tube 10 is elastically deformable radially and longitudinally.

Specifically, in supply of a fluid such as compressed air or liquid to an internal space 11a of the tube body 11, the elastic tube 10 is expanded radially outward and is contracted to shorten its overall length by a pressure of the supplied fluid. This elastic tube 10 is also referred to as a McKibben artificial muscle. In addition, as illustrated in FIG. 1, the elastic tube 10 includes adapters 13 provided at both ends of the tube. As such an elastic tube, an actuator element disclosed in, for example, Japanese Patent Application Laid-Open Publication No. 2021-099141, can be used.

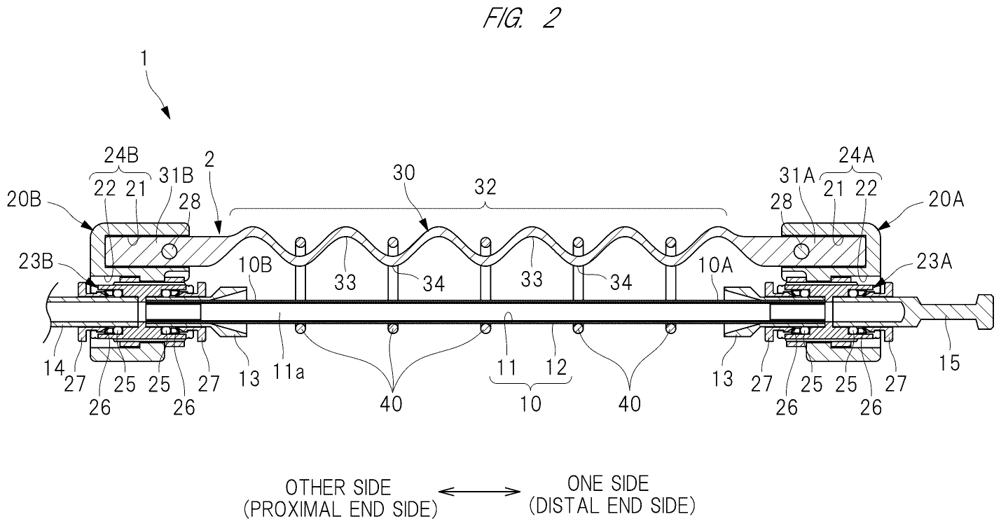

As illustrated in FIGS. 1 and 2, the joint holder 20A is mounted on a first end 10A serving as a one-side end of the elastic tube 10. In addition, the joint holder 20B is mounted on a second end 10B serving as the other-side end of the elastic tube 10. In the following description, note that the one side is referred to as a distal end side while the other side is referred to as a proximal end side.

As illustrated in FIG. 2, the joint holder 20A on the distal end side includes a block 24A in which an attachment hole 21 and a through hole 22 are formed. A connection part 31A provided at an end of the plate member 30 is inserted into the attachment hole 21 of the block 24A. The connection part 31A inserted into the attachment hole 21 is fixed to the joint holder 20A by a pin 28. In addition, a joint 23A is held in the through hole 22 of the block 24A. A plug 15 is inserted into this joint 23A from its one side, and the elastic tube 10 is inserted into the joint 23A from its other side.

The joint 23A includes a seal member 25, a lock tab 26, and a release ring 27. A space between the joint 23A and the plug 15 is sealed by the seal member 25, and the plug 15 is fixed to the joint 23A by the lock tab 26. Similarly, a space between the joint 23A and the elastic tube 10 is sealed by the seal member 25, and the elastic tube 10 is fixed to the joint 23A by the lock tab 26. In addition, when the release ring 27 is pushed, engagement of the lock tab 26 with the elastic tube 10 or the plug 15 can be canceled, and the elastic tube 10 or the plug 15 can be removed from the joint 23A.

Similarly, the joint holder 20B on the proximal end side includes a block 24B in which an attachment hole 21 and a through hole 22 are formed. A connection part 31B provided at an end of the plate member 30 is inserted into the attachment hole 21 of the block 24B. The connection part 31B inserted into the attachment hole 21 is fixed to the joint holder 20B by a pin 28. In addition, a joint 23B is held in the through hole 22 of the block 24B. The elastic tube 10 is inserted into this joint 23B from its one side, and the supply/exhaust tube 14 is inserted into the joint 23B from its other side.

The joint 23B includes a seal member 25, a lock tab 26, and a release ring 27. A space between the joint 23B and the supply/exhaust tube 14 is sealed by the seal member 25, and the supply/exhaust tube 14 is fixed to the joint 23B by the lock tab 26. Similarly, a space between the joint 23B and the elastic tube 10 is sealed by the seal member 25, and the elastic tube 10 is fixed to the joint 23B by the lock tab 26. In addition, when the release ring 27 is pushed, engagement of the lock tab 26 with the elastic tube 10 or the supply/exhaust tube 14 can be canceled, and the elastic tube 10 or the supply/exhaust tube 14 can be removed from the joint 23B.

The supply/exhaust tube 14 and the elastic tube 10 communicate with each other via the joint 23B. In addition, an air pressure source is connected to the supply/exhaust tube 14 via a valve unit not illustrated. The valve unit is controlled, thereby supplying the compressed air from the supply/exhaust tube 14 to the elastic tube 10. In addition, the valve unit is controlled, thereby exhausting the compressed air from the elastic tube 10 to the supply/exhaust tube 14.

The plate member 30 is provided between the joint holder 20A and the joint holder 20B. The plate member 30 is arranged outside the elastic tube 10. The plate member 30 is configured using a thin plate made of, for example, plastic or a metal. The plate member 30 is self-supporting, flexible, and restorable. That is, when no external force is applied to the plate member 30, the plate member 30 is self-supporting, in other words, retains its own shape. In addition, when an external force is applied to the plate member 30, the plate member 30 is warped. When the external force applied to the plate member 30 is removed, the plate member 30 is restored.

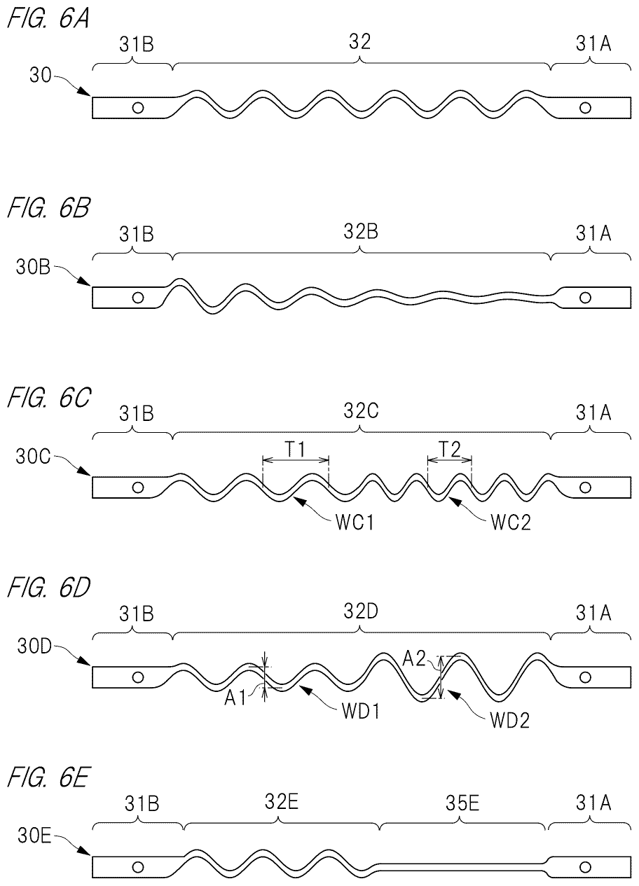

The plate member 30 includes the connection part 31A provided at one end, the connection part 31B provided at the other end, and a corrugated part 32 provided between the connection part 31A and the connection part 31B. The connection part 31A is a site held in the attachment hole 21 of the joint holder 20A, and the connection part 31B is a site held in the attachment hole 21 of the joint holder 20B. The corrugated part 32 has a shape made of repetition of a peak part 33 and a valley part 34. In an illustrated example, a plurality of waves constituting the corrugated part 32 respectively have the same period and amplitude. In addition, in the illustrated example, the corrugated part 32 has four peak parts 33 and five valley parts 34, but the present invention is not limited to this, and the respective numbers of peak parts 33 and valley parts 34 constituting the corrugated part 32 may be changed. Note that a modification example of the corrugated part 32 will be described later with reference to FIGS. 6A, 6B, 6C, 6D, and 6E.

The O-ring 40 is attached to surround the plate member 30 and the elastic tube 10, and holds the plate member 30 and the elastic tube 10. In addition, the O-ring 40 as an annular member is hooked on the valley part 34 of the corrugated part 32 constituting the plate member 30. The O-ring 40 is hooked on the valley part 34 as described above, and therefore, even when the elastic tube 10 is deformed by air pressure, the O-ring 40 is prevented from being unhooked from the valley part 34 and coming closer to the end of the plate member 30. For example, the O-ring 40 is made of an elastic body such as rubber. Since a frictional force is generated between the O-ring 40 and the valley part 34 and between the O-ring 40 and the elastic tube 10, slip of the O-ring 40 on the plate member 30 and the elastic tube 10 is suppressed.

### Operation of Fluid Pressure Actuator

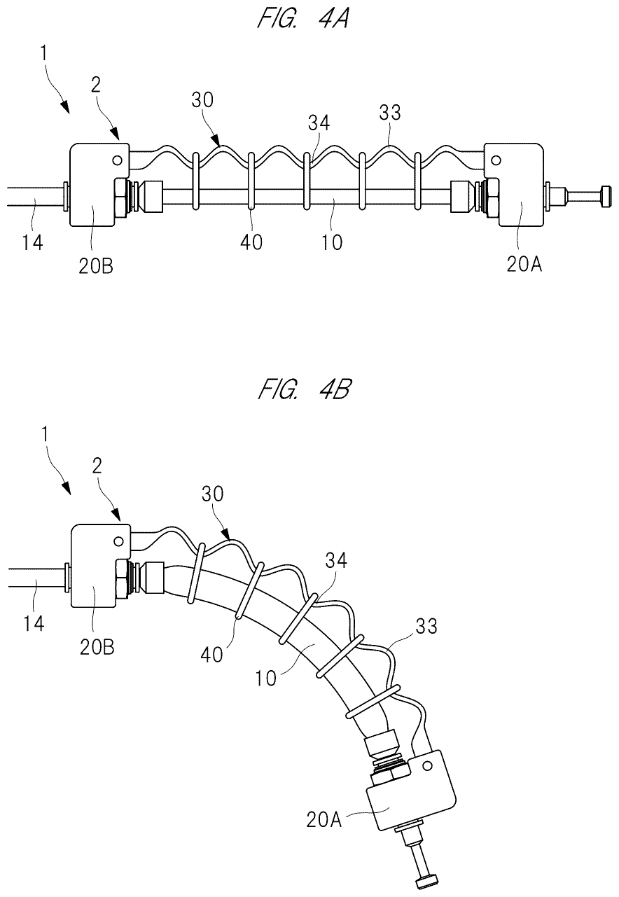

FIGS. 4A and 4B are diagrams each illustrating the fluid pressure actuator 1. FIG. 4A illustrates an initial state as an unpressurized state of the fluid pressure actuator 1, and FIG. 4B illustrates a bending state as a pressurized state of the fluid pressure actuator 1. As illustrated in FIG. 4A, by the supply of the compressed air from the supply/exhaust tube 14 to the internal space 11a of the tube body 11 in a state in which the joint holder 20B on the proximal end side is fixed to a stage or the like not illustrated, the supply/exhaust tube 14 and the plate member 30 in the fluid pressure actuator 1 are bent as illustrated in FIG. 4B.

As illustrated in FIG. 4B, in the bending state of the fluid pressure actuator 1, the elastic tube 10 is radially expanded and axially contracted. At this time, the elastic tube 10 is axially, i.e., longitudinally contracted while the contraction of the plate member 30 in the longitudinal direction is limited. Accordingly, the elastic tube 10 and the plate member 30 in the fluid pressure actuator 1 are bent. That is, the fluid pressure actuator 1 is bent such that the elastic tube 10 is arranged inside while the plate member 30 is arranged outside. By the exhaust of the compressed air from the internal space 11a of the elastic tube 10, note that the fluid pressure actuator 1 returns to the initial state by a restoring force of the plate member 30 as illustrated in FIG. 4A.

As described above, the plate member 30 is self-supporting, flexible, and restorable. Therefore, as illustrated in FIG. 4A, the plate member 30 retains its initial shape even in a situation of the exhaust of the compressed air from the elastic tube 10, and therefore, the fluid pressure actuator 1 is retained in the initial state where it linearly extends. Thus, the fluid pressure actuator 1 can maintain its posture of the initial state.

As illustrated in FIG. 4B, when the contraction force of the elastic tube 10 in the longitudinal direction is increased by the supply of the compressed air to the elastic tube 10, the plate member 30 is warped in response to the contraction force of the elastic tube 10. Accordingly, the fluid pressure actuator 1 changes from the initial state to the bending state. Then, when the contraction force of the elastic tube in the longitudinal direction 10 is decreased by the exhaust of the compressed air from the elastic tube 10 under the bending state illustrated in FIG. 4B, the plate member 30 is returned to the initial shape by the restoring force of the plate member 30. Accordingly, the fluid pressure actuator 1 changes from the bending state to the initial state.

In addition, a degree of the bending of the fluid pressure actuator 1, i.e., a position of the joint holder 20A moved by the bending of the fluid pressure actuator 1 is determined by a magnitude balance between the contraction force of the elastic tube 10 and the restoring force of the plate member 30. That is, when a pressure of the compressed air supplied to the elastic tube 10 is kept constant, the contraction force of the elastic tube 10 can be kept constant. Accordingly, the bending state of the fluid pressure actuator 1 can be retained. Thus, the fluid pressure actuator 1 can maintain its posture of the bending state.

As described above, the fluid pressure actuator 1 as well as the attachment 2 includes the joint holders 20A and 20B mounted on the elastic tube 10 and the plate member 30 provided between the joint holders 20A and 20B. Moreover, a mounting structure of the plate member 30 is not a structure inserted into the elastic tube 10 but a structure arranged outside the elastic tube 10. In this manner, the fluid pressure actuator 1 and the attachment 2 can be easily configured, and the respective costs of the fluid pressure actuator 1 and the attachment 2 can be reduced.

### Gripping Device

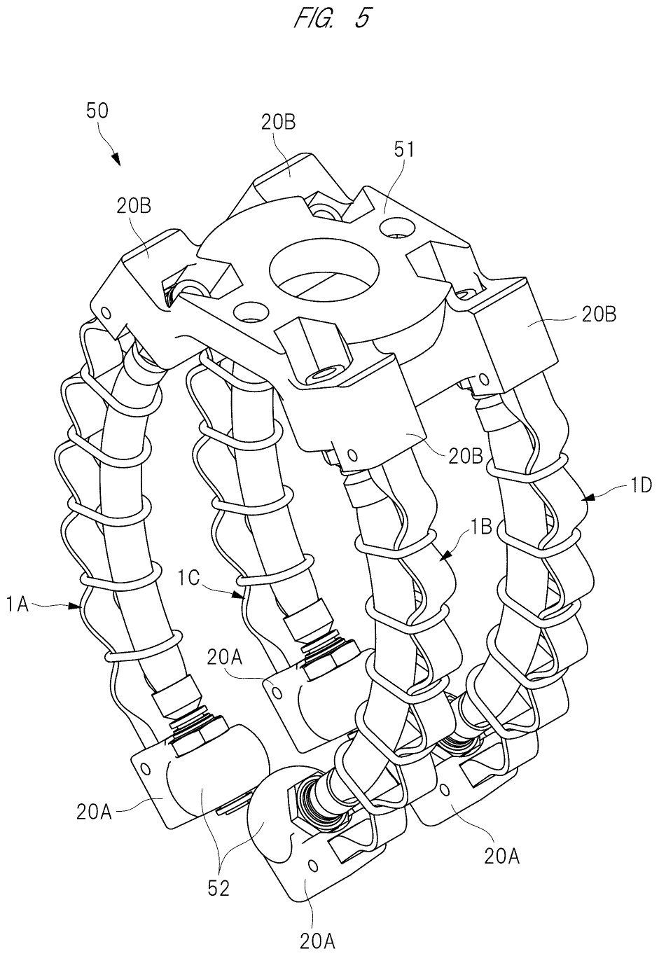

The fluid pressure actuator 1 is used for, for example, a gripping device 50 illustrated in FIG. 5. The gripping device 50 includes a stage 51 and four fluid pressure actuators 1. In the following description, the four fluid pressure actuators 1 are respectively denoted by reference symbols 1A, 1B, 1C, and 1D from the viewpoint of distinguishing the fluid pressure actuators 1.

The fluid pressure actuators 1A and 1B are arranged to face each other. The fluid pressure actuators 1C and 1D are arranged to face each other. The pair of fluid pressure actuators 1A and 1B and the pair of fluid pressure actuators 1C and 1D are arranged in parallel with each other.

The stage 51 of the gripping device 50 is used while being attached to a robot such as a conveyor robot not illustrated. The joint holders 20B of the respective fluid pressure actuators 1A, 1B, 1C and 1D are provided integrally with the stage 51. In addition, the joint holders 20A of the respective fluid pressure actuators 1A, 1B, 1C and 1D are provided with a soft pad 52.

In the gripping device 50, the compressed air is supplied to the respective elastic tubes 10 of the four fluid pressure actuators 1A, 1B, 1C and 1D, thereby bending the fluid pressure actuators 1A, 1B, 1C and 1D. In this manner, the respective pads 52 of the fluid pressure actuators 1A, 1B, 1C and 1D can be brought in close to one another, and a workpiece not illustrated can be softly gripped by the pads 52.

### Modification Example of Plate Member

FIGS. 6A, 6B, 6C, 6D and 6E respectively illustrate plate members 30, 30B, 30C, 30D and 30E. FIG. 6A illustrates the plate member 30 illustrated in FIGS. 1 and 2. FIGS. 6B, 6C, 6D, and 6E respectively illustrate the plate members 30B, 30C, 30D, and 30E according to another modification examples.

As illustrated in FIG. 6A, the plate member 30 includes the connection parts 31A and 31B at both its ends, and includes the corrugated part 32 between the connection parts 31A and 31B. In a cross section of the corrugated part 32 included in the plate member 30 in the longitudinal direction, at least one of an outline and a center line of the cross-sectional shape includes a sine curve. That is, a shape of the corrugated part 32 included in the plate member 30 is a sine curve shape.

The plate members 30B, 30C, 30D, and 30E illustrated in FIGS. 6B, 6C and 6D respectively have corrugated parts 32B, 32C, 32D, and 32E having different shapes from that of the corrugated part 32 in the plate member 30.

As illustrated in FIG. 6B, the plate member 30B includes connection parts 31A and 31B at both its ends, and includes the corrugated part 32B between the connection parts 31A and 31B. In a cross section of the corrugated part 32B included in the plate member 30B in the longitudinal direction, at least one of an outline and a center line of the cross-sectional shape includes a decay curve. That is, a shape of the corrugated part 32 included in the plate member 30B is a decay curve shape. Note that the decay curve is a curve, the amplitude of which decreases in the longitudinal direction.

As illustrated in FIG. 6C, the plate member 30C includes connection parts 31A and 31B at both its ends, and includes the corrugated part 32C between the connection parts 31A and 31B. In a cross section of the corrugated part 32C included in the plate member 30C in the longitudinal direction, at least one of an outline and a center line of the cross-sectional shape includes a curve made of a plurality of waves. This curve includes a wave WC1 having a period T1 and a wave WC2 having a period T2 shorter than the period T1. That is, a shape of the corrugated part 32C included in the plate member 30C is a curve shape including a plurality of waves respectively having different periods. Note that the curve illustrated in FIG. 6C is a curve including the two waves WC1 and WC2 respectively having different periods. However, the present invention is not limited to this, and the curve may include three or more waves respectively having different periods.

As illustrated in FIG. 6D, the plate member 30D includes connection parts 31A and 31B at both its ends, and includes the corrugated part 32D between the connection parts 31A and 31B. In a cross section of the corrugated part 32D included in the plate member 30D in the longitudinal direction, at least one of an outline and a center line of the cross-sectional shape includes a curve made of a plurality of waves. This curve includes a wave WD1 having an amplitude A1 and a wave WD2 having an amplitude A2 larger than the amplitude A1. That is, a shape of the corrugated part 32D included in the plate member 30D is a curve shape including a plurality of waves respectively having different amplitudes. Note that the curve illustrated in FIG. 6D is a curve including the two waves WD1 and WD2 respectively having different amplitudes. However, the present invention is not limited to this, and the curve may include three or more waves respectively having different amplitudes.

As illustrated in FIG. 6E, the plate member 30E includes connection parts 31A and 31B at both its ends, and includes the corrugated part 32E and a flat plate part 35E between the connection parts 31A and 31B. By the use of the plate member 30E made of the corrugated part 32E and the flat plate part 35E, the degree of the bending of the fluid pressure actuator 1 in the longitudinal direction can be changed. That is, a degree of the bending of the corrugated part 32 can be made larger than that of the flat plate part 35E. In other words, a radius of curvature in the corrugated part 32 can be made smaller than a radius of curvature in the flat plate part 35E.

Shapes of the corrugated parts 32, 32B, 32C, 32D and 32E are not respectively limited to the shapes illustrated in FIGS. 6A, 6B, 6C and 6D. The corrugations constituting the corrugated parts 32, 32B, 32C, 32D and 32E may be combined. In addition, the example illustrated in FIG. 6E adopts the combination of the one corrugated part 32E and the one flat plate part 35E. However, the present invention is not to this example, and two or more corrugated parts 32E may be combined, or two or more flat plate parts 35E may be combined. That is, the plate members 30, 30B, 30C, 30D and 30E each constituting a part of the fluid pressure actuator 1 and the attachment 2 may respectively include the corrugated parts 32, 32B, 32C, 32D and 32E at least partially in the longitudinal direction. In addition, by optional combination of the corrugations of the illustrated corrugated parts 32, 32B, 32C, 32D and 32E, the fluid pressure actuator 1 can be controlled to a desired bending state.

Note that each shape of the peak part 33 and the valley part 34 constituting each of the corrugated parts 32, 32B, 32C, 32D, and 32E is preferably formed to the curve shape as illustrated in FIGS. 6A, 6B, 6C, 6D, and 6E. That is, each shape of the peak part 33 and the valley part 34 is preferably formed to the curve shape from the viewpoint of relaxing the respective stress concentrations on the peak part 33 and the valley part 34 during bending.

### Modification Example of Fluid Pressure Actuator and Attachment

The present disclosure is not limited to the above embodiments, and various modifications can be made within the scope of the present invention.

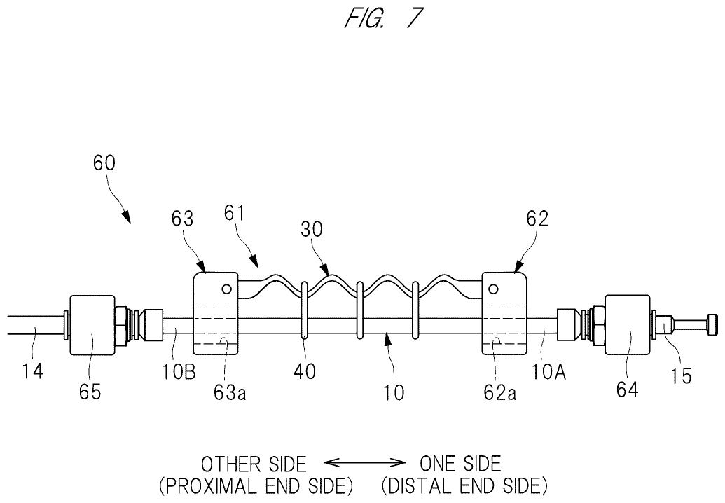

In the example illustrated in FIG. 2, the joints 23A and 23B are respectively attached to the joint holders 20A and 20B. However, the present invention is not limited to this example. A structure in which the joints 23A and 23B are respectively spaced apart from the joint holders 20A and 20B is also applicable. Here, FIG. 7 is a diagram illustrating a modification example of the fluid pressure actuator and the attachment.

As illustrated in FIG. 7, a fluid pressure actuator 60 includes the elastic tube 10 and an attachment 61 mounted on the elastic tube 10. The attachment 61 includes a holder (first holder) 62 for mounting on the elastic tube 10 and a holder (second holder) 63 for mounting on the elastic tube 10. The holders 62 and 63 are respectively provided with through holes 62a and 63a through which the elastic tube 10 passes. In addition, the attachment 61 includes a plate member 30 provided between the holder 62 and the holder 63 and an O-ring 40 for holding the plate member 30 and the elastic tube 10.

The holder 62 of the attachment 61 is attached to a first end 10A of the elastic tube 10, and faces a joint 64 attached to the first end 10A. In addition, the holder 63 of the attachment 61 is attached to a second end 10B of the elastic tube 10, and faces a joint 65 attached to the second end 10B. Here, respective inner diameter dimensions of the through holes 62a and 63a formed in the holders 62 and 63 are smaller than respective outer diameter dimensions of the joints 64 and 65.

In the fluid pressure actuator 60 including this attachment 61, when the elastic tube 10 is axially contracted by the supply of the compressed air to the elastic tube 10, the joint 64 is moved to come close to the holder 62 while the joint 65 is moved to come close to the holder 63. Then, after the joint 64 is in contact with the holder 62 while the joint 65 is in contact with the holder 63, the bending operation of the fluid pressure actuator 60 is started. In this case, the attachment 61 is not fixed to the elastic tube 10. Accordingly, when the attachment 61 is rotated in a circumferential direction of the elastic tube 10, a bending direction of the fluid pressure actuator 60 can be freely changed.

In the above description, the O-ring 40 made of rubber is used as the coupling member that gently bundles the plate member 30 and the elastic tube 10. However, the present invention is not limited to this, and an annular member made of a metal material or a resin material is also application to the coupling member. In addition, the shape of the coupling member is not limited to the annular member having the circular shape, the elliptical shape, or the like. That is, it is needless to say that any shape is applicable if the shape can connect the plate member 30 and the elastic tube 10 to each other. In addition, in the above description, the compressed air is used as the fluid to be supplied to the elastic tube 10. However, the present invention is not limited to this, and gas other than the compressed air may be used as the fluid, or liquid may be used as the fluid.

### Reference Signs List

1, 1A, 1B, 1C, 1D . . . fluid pressure actuator
2 . . . attachment
10 . . . elastic tube
10A . . . first end
10B . . . second end
11 . . . tube body
12 . . . braided sleeve (reinforcement member)
20A . . . joint holder (first holder)
20B . . . joint holder (second holder)
30, 30B, 30C, 30D, 30E . . . plate member
32, 32B, 32C, 32D, 32E . . . corrugated part
34 . . . valley part
40 . . . O-ring (coupling member, annular member)
60 . . . fluid pressure actuator
61 . . . attachment
62 . . . holder (first holder)
63 . . . holder (second holder)
A1, A2 . . . amplitude
T1, T2 . . . period
WC1, WC2, WD1, WD2 . . . wave

What is claimed is:

1. A fluid pressure actuator comprising:
an elastic tube including a tube body and a reinforcement member and being radially expanded and axially contracted by a fluid pressure supplied to the tube body;
a first holder mounted on a first end of the elastic tube;
a second holder mounted on a second end of the elastic tube;
a plate member being provided between the first holder and the second holder, being arranged outside the elastic tube, and having a corrugated part; and
a coupling member holding the plate member and the elastic tube.

2. The fluid pressure actuator according to claim 1, wherein a shape of the corrugated part is a sine curve shape.

3. The fluid pressure actuator according to claim 1, wherein a shape of the corrugated part is a decay curve shape.

4. The fluid pressure actuator according to claim 1, wherein a shape of the corrugated part is a curve shape including a plurality of waves respectively having different periods.

5. The fluid pressure actuator according to claim 1, wherein a shape of the corrugated part is a curve shape including a plurality of waves respectively having different amplitudes.

6. The fluid pressure actuator according to claim 1, wherein the reinforcement member is a mesh-like structure being provided outside the tube body and being made of cylindrically braided threads.

7. The fluid pressure actuator according to claim 1, wherein the coupling member is an annular member mounted on a valley part of the corrugated part and the elastic tube.

8. An attachment used while being mounted on an elastic tube being radially expanded and axially contracted by a fluid pressure supplied to a tube body, comprising:
a first holder for mounting on the elastic tube;
a second holder for mounting on the elastic tube;
a plate member being provided between the first holder and the second holder and including a corrugated part; and
a coupling member for holding the plate member and the elastic tube.
